(19) United States
(12) Patent Application Publication
(10) Pub. No.: US 2026/0246107 A1
(43) Pub. Date: Aug. 20, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventor: Dong Bok YANG, Yongin-si (KR)

(21) Appl. No.: 19/454,591

(22) Filed: Jan. 21, 2026

(30) Foreign Application Priority Data
Feb. 20, 2025 (KR) 10-2025-0021917

(51) Int. Cl. H01M 50/533; H01M 4/66; H01M 50/534

(52) U.S. Cl. CPC H01M 50/533; H01M 4/661; H01M 4/667; H01M 50/534

(57) ABSTRACT

An electrode assembly comprises a first electrode, a second electrode, and a separator between the first electrode and the second electrode. The first electrode comprises a first current collector comprising a first uncoated portion, a first active material layer on the first current collector, and a plurality of first electrode tabs formed by the first uncoated portion and comprising a connection region. The second electrode comprises a second current collector comprising a second uncoated portion, a second active material layer on the second current collector, and a plurality of second electrode tabs formed by the second uncoated portion and comprising a connection region. At least one of the first current collector and the second current collector comprises a resin layer and a metal layer on surfaces of the resin layer.

### CROSS-REFERENCE TO THE RELATED APPLICATION

The present application claims priority to and the benefit of Korean Patent Application No. 10-2025-0021917, filed on Feb. 20, 2025, in the Korean Intellectual Property Office, the entire disclosure of which is incorporated herein by reference.

### BACKGROUND

### 1. Field

Embodiments relate to an electrode assembly and a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a secondary battery having improved energy density per weight.

An electrode assembly according to an embodiment comprises a first electrode, a second electrode, and a separator between the first electrode and the second electrode, the first electrode comprises a first current collector comprising a first uncoated portion, a first active material layer on the first current collector, and a plurality of first electrode tabs formed by the first uncoated portion and comprising a connection region, the second electrode comprises a second current collector comprising a second uncoated portion, a second active material layer on the second current collector, and a plurality of second electrode tabs formed by the second uncoated portion and comprising a connection region, at least one of the first current collector and the second current collector comprises a resin layer and a metal layer on surfaces of the resin layer, a connection member is disposed on the connection region of at least one of the first electrode tabs and the second electrode tabs, and the connection member comprises an accommodating member that accommodates the first electrode tabs or the second electrode tabs, a plurality of coupling members penetrating the first electrode tabs or the second electrode tabs, and a cover member that covers the first electrode tabs or the second electrode tabs.

The accommodating member comprises a bottom surface disposed under a lowermost electrode tab of the first electrode tabs or the second electrode tabs, and the coupling members are disposed on the bottom surface.

Each of the coupling members comprises a lower surface on the bottom surface and an upper surface, and a width of each of the coupling members decreases from the lower surface to the upper surface.

The area of the coupling members is 50% to 80% of a total area of the bottom surface.

The length of each of the coupling members is 1 to 1.1 times the sum of the thicknesses of the first electrode tabs or the second electrode tabs.

The accommodating member further comprises a first side and a second side connected to the bottom surface, the first side covers the side of the first electrode tabs or the second electrode tabs in the longitudinal direction of the first electrode tabs or the second electrode tabs, and the second side covers the side of the first electrode tabs or the second electrode tabs in the width direction of the first electrode tabs or the second electrode tabs.

The connecting region is formed at an end of the first electrode tabs or the second electrode tabs.

The connection region is formed in a region between the ends of the first electrode tabs or the second electrode tabs

The coupling members comprise a conductive material.

The accommodating member and the cover member comprise a metal or a non-metal.

The connection member further comprises a second coupling members disposed on the lower surface of the cover member, and the second coupling member are offset from the first coupling members.

The lengths of the accommodating member and the cover member are different.

The length of the cover member is longer than the length of the accommodating member.

The cover member is disposed over the area between the ends of the first electrode tabs or the second electrode tabs and disposed the outer regions of the first electrode tabs or the second electrode tabs.

The coupling member and the cover member comprise metal.

The accommodating member comprises metal or non-metal.

The cover member comprises the same metal as the first collector or the second collector.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a secondary battery according to an embodiment of the present disclosure.

FIG. 2 is a top view showing an electrode assembly according to an embodiment of the present disclosure.

FIG. 3 is a cross-sectional view showing the region A-A′ of FIG. 2.

FIG. 4 is a cross-sectional view showing the region B-B′ of FIG. 2.

FIG. 5 is a side view showing the electrode assembly according to an embodiment of the present disclosure.

FIG. 6 is a view explaining a connection region of an electrode tab according to an embodiment of the present disclosure.

FIG. 7 is a perspective view showing the electrode tab and a connection member according to an embodiment of the present disclosure.

FIG. 8 is a cross-sectional view showing the region C-C′ of FIG. 6.

FIG. 9 is another cross-sectional view showing the region C-C′ of FIG. 6.

FIG. 10 is a view explaining the connection region of the electrode tab according to another embodiment of the present disclosure.

FIG. 11 is a perspective view showing the electrode tab and the connecting member according to another embodiment of the present disclosure.

FIG. 12 is a cross-sectional view showing the region D-D′ of FIG. 10.

FIG. 13 is a cross-sectional view showing the region E-E′ of FIG. 10.

FIG. 14 is a cross-sectional view showing the region F-F′ region of FIG. 10.

FIGS. 15 and 16 are perspective views showing a battery pack including secondary batteries according to embodiments of the present disclosure.

FIGS. 17 and 18 are perspective views and a side view showing a vehicle including battery packs according to embodiments of the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly and a secondary battery according to an embodiment of the present disclosure will be described with reference to the drawings.

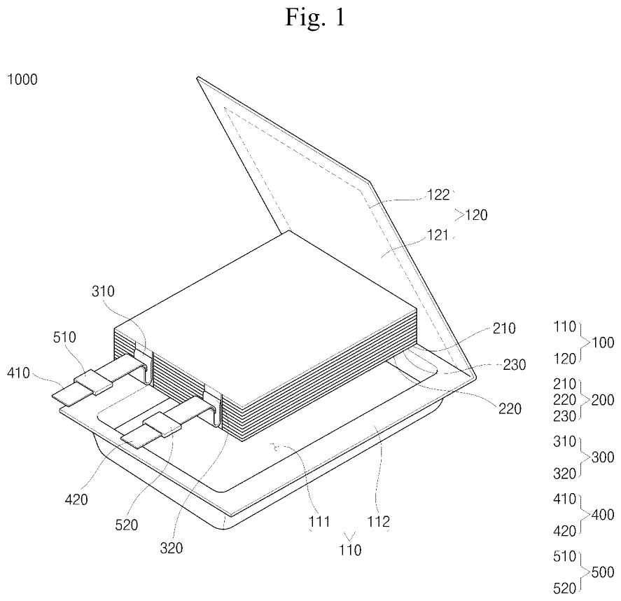

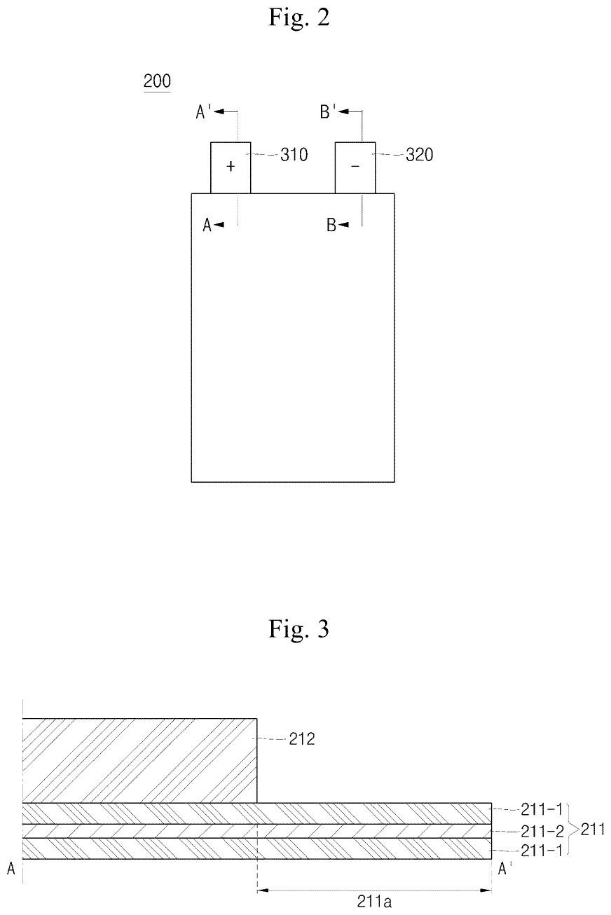

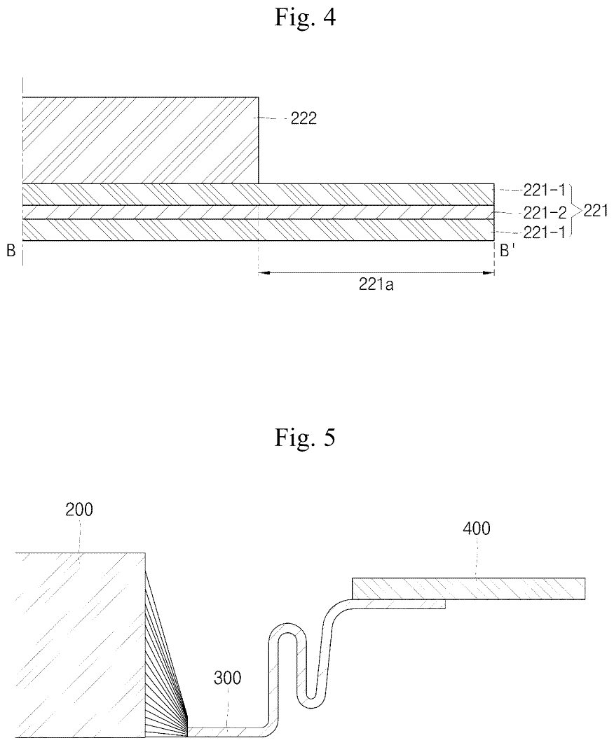

Referring to FIGS. 1 to 4, the secondary battery according to the embodiment may include a case 100 and an electrode assembly 200.

The case 100 may include an accommodation part 110 and a cap part 120. The accommodation part 110 and the cap part 120 may be connected. The case 100 may be formed in a pouch shape. The accommodation part 110 may include a concave part 111 and a first sealing region 112. The accommodation part 110 may include an accommodating space. In detail, the accommodation part 110 may include an inner bottom surface and an inner side surface formed by the concave part 111. The accommodating space may be formed by the inner bottom surface and the inner side surface.

The first sealing region 112 may be disposed at the edge of the accommodation part 110. A sealing layer may be disposed on the first sealing region 112.

The cap part 120 may include a cover part 121 and a second sealing region 122. The cover part 121 may cover the accommodation part 110. Specifically, the cover part 121 may cover the electrode assembly 200 accommodated in the accommodation part 110.

The second sealing region 122 may be disposed at the edge of the cap part 120. The sealing layer may be disposed on the second sealing region 122. The first sealing region 112 and the second sealing region 122 may overlap each other. In detail, when the accommodation part 110 is covered by the cap part 120, the first sealing region 112 and the second sealing region 122 may face and contact each other. Therefore, the accommodation part 110 and the cap part 120 may be bonded by the sealing layer.

The electrode assembly 200 may be accommodated in the case 100. In particular, the electrode assembly 200 may be accommodated in the accommodating space of the case together with the electrolyte.

In the drawing, one electrode assembly is illustrated as being accommodated in the case. However, embodiments of the present disclosure are not limited to such an arrangement. In other embodiments, two or more electrode assemblies may be accommodated in the case.

The electrode assembly 200 may include a first electrode 210, a second electrode 220, and a separator 230. The electrode assembly 200 may be formed by stacking the first electrode 210, the second electrode 220, and the separator 230. For example, the electrode assembly may be a Z-stack electrode assembly in which the first electrode 210 and the second electrode 220 are provided on both sides of a separator 230 and then folded into a Z-stack. In other embodiments the electrode assembly 200 may be formed by winding the first electrode 210, the second electrode 220, and the separator 230.

The first electrode 210 may include a first current collector 211 and a first active material layer 212 on the first current collector 211. The first current collector 211 may include a conductive material and a non-conductive material. For example, the first current collector 211 may include a plurality of first metal layers 211-1 and a first resin layer 211-2. The first metal layer 211-1 may be disposed on both surfaces of the first resin layer 211-2.

The first metal layer 211-1 may be formed from a metal foil such as aluminum or an aluminum alloy. The first resin layer 211-2 may include polyethylene terephthalate (PET). That is, the first current collector may be a composite substrate including a metallic material and a non-metallic material. The first active material layer 212 may include a transition metal oxide. In some examples, the first electrode 210 may be a positive electrode.

The first electrode 210 may be connected to a first electrode tab 310. The first active material layer is not provided on the first electrode tab 310. The first electrode tab 310 may be formed integrally with the first current collector. For example, the first current collector may include a first uncoated portion 211a where the first active material layer is not provided. The first uncoated portion may be notched. The first electrode tab 310 may be formed by the first uncoated portion. Therefore, the first electrode tab 310 may be formed from the same material as the first current collector. That is, the first electrode tab 310 may be formed as a composite substrate including metallic and non-metallic materials.

The second electrode 220 may include a second current collector 221 and a second active material layer 222 on the second current collector 221. The second current collector 221 may include the conductive material and the non-conductive material. For example, the second current collector 221 may include a plurality of second metal layers 221-1 and a second resin layer 221-2. The second metal layer 221-1 may be disposed on both surfaces of the second resin layer 221-2.

The second metal layer 221-1 may be formed from a metal foil such as copper, a copper alloy, nickel, or a nickel alloy. The second resin layer 221-2 may include polyethylene terephthalate (PET). That is, the second current collector may be the composite substrate including metallic and non-metallic materials. The second active material layer 222 may include graphite or carbon. In some examples, the second electrode 220 may be a negative electrode.

The second electrode 220 may be connected to a second electrode tab 320. The second active material is not provided on the second electrode tab 320. The second electrode tab 320 may be formed integrally with the second current collector. For example, the second collector may include a second uncoated portion 221a where the second active material layer is not provided. The second uncoated portion may be notched. The second electrode tab 320 may be formed by the second uncoated portion. Thus, the second electrode tab 320 may be formed from the same material as the second current collector. That is, the second electrode tab 320 may be formed by the composite substrate including the metallic and non-metallic materials.

The first electrode tab 310 and the second electrode tab 320 may each be connected to a lead. For example, the first electrode tab 310 may be connected to the first external terminal by the first lead 410. Similarly, the second electrode tab 320 may be connected to a second lead 420 by the second lead 420. The first lead 410 may be formed from the same material as the first electrode tab, and the second lead 420 may be formed from the same material as the second electrode tab. The electrode tabs 300 and the leads 400 may be joined by welding.

The first current collector 211 and the second current collector 221 may be composite substrates. Thus, the weight of the first current collector 211 and the second current collector 221 may be reduced as compared, for example, to current collectors that are made from only metallic materials. Accordingly, the weight of the electrode assembly may be reduced, which results in the energy density per weight of the electrode assembly being increased.

An insulating layer may be disposed on the leads. For example, a first insulating layer 510 surround a region of the first lead 410. Similarly, a second insulating layer 520 may surround a region of the second lead 420. The lead 400 may be insulated from the case 100 by the insulating layer 500. And the lead 400 and the case 100 may be easily bonded and insulated by the insulating layer 500 and the sealing layer.

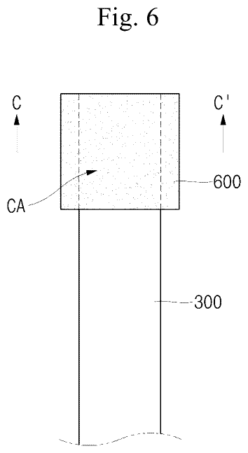

Referring to FIG. 5, a plurality of electrode tabs 300 are electrically connected. For example, a plurality of electrode tabs may be electrically connected in a connection region. The electrode tabs may be coupled to the lead 400 by welding after being bent at least once.

Conventionally, electrode tabs are coupled by welding. However, as described above, the first electrode tab and the second electrode tab according to embodiments of the present disclosure include the resin layer. Therefore, even if a plurality of electrode tabs are welded, the plurality of electrode tabs are not electrically connected by the resin layer. Accordingly, a process of further forming a separate substrate tab on the electrode tabs and then welding the separate substrate tab was required. But the electrode assembly according to- an embodiment of the present disclosure includes a connecting member. Accordingly, a plurality of electrode tabs may be electrically connected without forming a separate substrate tab.

Hereinafter, the electrode tab and the connecting member according to an embodiment of the present disclosure will be described with reference to the drawings. The following description may be applied to at least one of the first electrode tab and the second electrode tab.

Referring to FIG. 6, the electrode tab 300 may include a connection region CA. A plurality of electrode tabs formed on each current collector may be connected at the connection region CA. That is, electrode tabs may be coupled and electrically connected at the connection region CA.

The connection region CA is formed at a portion of the electrode tab 300. In the example depicted in FIG. 6, the connection region CA may be formed at an end region of the electrode tab 300. However, the present disclosure is not limited thereto. The connection region CA may be disposed at a region between both ends of the electrode tab 300.

The connection member 600 may be disposed on the connection region CA, with the electrode tabs coupled by the connection member 600. More specifically, the electrode tabs may be electrically connected by the connecting member 600.

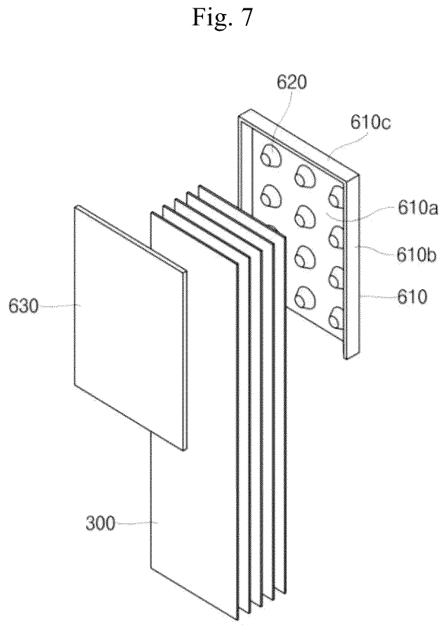

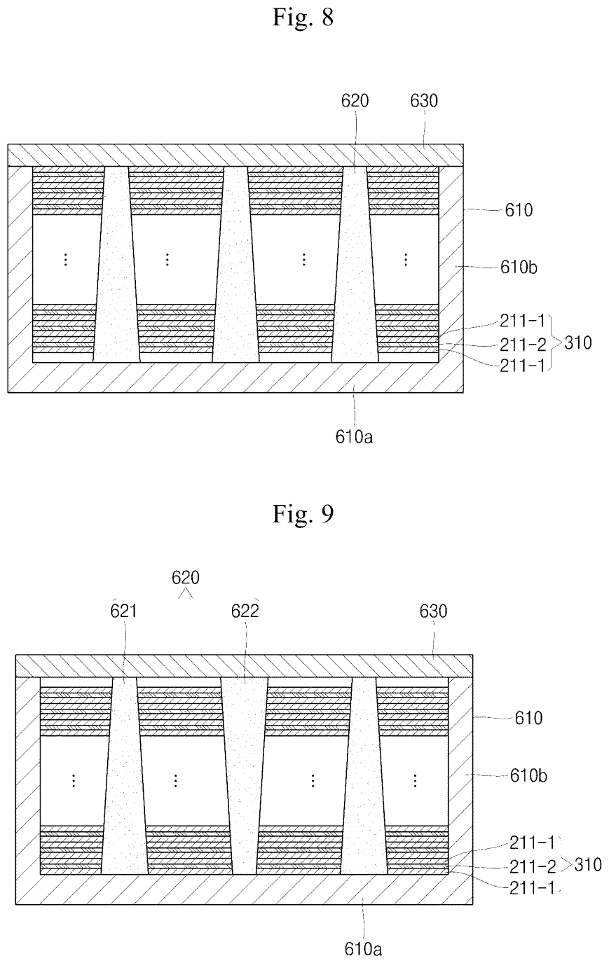

Referring to FIGS. 7 and 8, the connecting member 600 may include an accommodating member 610, a coupling member 620, and a cover member 630.

The electrode tabs may be accommodated in the accommodating member 610. More specifically, the accommodating member 610 may support the plurality of electrode tabs. The accommodating member 610 may include a bottom surface 610a. And the accommodating member 610 may optionally include at least one first side 610b and/or a second side 610c.

The bottom surface 610a is disposed under the electrode tabs. In detail, the bottom surface 610a and the lowermost electrode tab may face and contact each other. In other embodiments, the bottom surface 610a and the lowermost electrode tab may be spaced apart from each other.

The coupling member 620 may be disposed on the bottom surface 610a. In detail, the coupling member 620 may be coupled to the bottom surface 610a. The coupling member 620 may be a protrusion protruding from the bottom surface 610a. The coupling member 620 may include a conductive material. For example, the coupling member 620 may include a metal. The coupling member 620 may be formed from a material that is the same as or different from the first metal layer 211-1 or the second metal layer 221-1.

The width of the coupling member 620 may vary depending on position. In detail, the width of the coupling member 620 may increase in a direction toward the bottom surface. The coupling member 620 may include a lower surface and an upper surface, with the lower surface facing the bottom surface 610a. The width of the coupling member 620 may decrease from the lower surface to the upper surface. Therefore, the upper surface of the coupling member may have a pointed/pyramid shape.

The coupling member 620 may include one or more coupling members. The coupling members may be spaced apart from each other. The coupling member(s) 620 may be disposed in a set area. For example, the surface area(s) at the bottom(s) of the coupling member(s) 620 may be a total of 50% to 80%, 55% to 75%, or 60% to 70% of the total surface area of the bottom surface 610a. When the total surface area of bottom(s) the coupling member(s) is less than 50% of the area of the bottom surface, the area through which the current flowing through the electrode tab may move is reduced. Accordingly, the resistance of the electrode tab may increase, and the electrode tab may be heated. When the total surface area of bottoms of the coupling members is more than 80% of the area of the bottom surface, adjacent coupling members may interfere with each other, and some coupling members may not penetrate the electrode tabs.

The coupling member(s) 620 may be formed in various shapes. For example, the upper surface and the lower surface of the coupling member(s) may have a circular, polygonal, or cross-shaped shape.

The coupling member(s) 620 may have a set length. For example, the length of the coupling member(s) 620 may be 1 to 1.1 times the sum of the thicknesses of the electrode tabs. When the length of the coupling member(s) is less than 1 times the sum of the thicknesses of the electrode tabs, the coupling member(s) insufficiently penetrate the electrode tabs. When the length of the coupling member exceeds 1.1 times the sum of the thicknesses of the electrode tabs, the thickness of the connecting member may increase by the length of the coupling member.

The coupling member(s) 620 may penetrate the electrode tabs. In detail, the coupling member(s) 620 may penetrate the connecting region CA. For example, after the connecting regions of the electrode tabs are positioned on the coupling member(s) 620, pressure may be applied to the connecting region CA or the coupling member(s) 620. Accordingly, the coupling member(s) 620 may contact the connecting region.

In other embodiments, the connecting region CA may include a plurality of holes. The holes may be formed in a region corresponding to the position(s) of the coupling member(s). The sizes of the holes may be greater than the size of the upper surfaces of the coupling members. After the holes of the electrode tabs and the coupling members are aligned, pressure may be applied to the connecting region CA or the coupling members 620. Accordingly, the coupling members 620 may penetrate the connecting region.

With the above-described embodiments, the coupling member(s) 620 may penetrate the metal layer and resin layer of the electrode tabs. Therefore, the electrode tabs may be electrically connected by the coupling member(s) 620. Thus, a process of connecting a separate metal tab to each of the electrode tabs may be omitted, and the electrode tabs may be electrically connected without separate welding. Therefore, the electrode tabs including the composite substrate may be easily connected.

The cover member 630 may be disposed on the accommodating member 610. With such an arrangement, the electrode tabs are disposed between the cover member 630 and the accommodating member 610. The cover member 630 may cover the electrode tabs. Therefore, the uppermost electrode tab and the cover member 630 may face each other, and the uppermost electrode tab and the cover member 630 may contact each other. But in other embodiments, the uppermost electrode tab and the cover member 630 may be spaced apart from each other.

The accommodating member 610 may further include sides connected to the bottom surface. For example, the accommodating member 610 may further include at least one of a first side 610b and a second side 610c.

The first side 610b extends in the longitudinal direction of the electrode tabs such that the first side 610b may cover sides of the electrode tabs in the longitudinal direction. The second side 610c extends in the width direction of the electrode tabs such that the second side 610c may cover sides of the electrode tabs in the width direction.

In some embodiments, the accommodating member 610 may include only the bottom surface 610a. In other embodiments, the accommodating member 610 may include the bottom surface 610a and the first side 610b, or the accommodating member 610 may include the bottom surface 610a and the second side 610c, or the accommodating member 610 may include the bottom surface 610a, the first side 610b, and the second side 610c. Those skilled in the art will recognize further possible configurations of the accommodating member 610.

Whether the second side 610c is included may depend on the location of the connection region CA. For example, when the connection region CA is disposed at the end regions of the electrode tabs, the accommodating member 610 may include the second side 610c. In another arrangement where the connection region CA is disposed in a region between the ends of the electrode tabs, the accommodating member 610 does not include the second side 610c.

The first side 610b and the second side 610c cover the sides of the electrode tabs. Accordingly, the electrode tabs may be stably disposed in the accommodation part by the sides. That is, the positions of the electrode tabs may be aligned by the sides, and the coupling of the electrode tab 300 and the connecting member 600 may be prevented from being misaligned.

The accommodating member 610 and the cover member 630 may before formed from metallic or the non-metallic materials. For example, the accommodating member 610 and the cover member 630 may include the same or different metals. Accordingly, the accommodating member 610 and the cover member 630 may be electrically conductive. Accordingly, the electrode tabs may be electrically connected even through the side of the accommodating member and current may flow to the accommodating member 610 and the cover member 630. Further, since the area through which the current flows is increased with such an arrangement, the resistance of the electrode tabs is decreased. When the accommodating member 610 and the cover member 630 include metal, the lead 400 may be connected to the accommodating member 610 or the cover member 630.

In some embodiments, the accommodating member 610 may include the metal, and the cover member 630 may include the non-metal. In this case, the lead 400 may be connected to the accommodating member 610. In other embodiments, the accommodating member 610 may include the non-metal, and the cover member 630 may include the metal. In this case, the lead 400 may be connected to the cover member 630.

In still further embodiments, the accommodating member 610 and the cover member 630 may include the non-metal. Therefore, the connecting member 600 may function as an insulator. In such a case, a conductive material may be disposed on the accommodating member 610 or the cover member 630. For example, a metal plate may be disposed on the accommodating member 610 or the cover member 630. The metal plate may be electrically connected to the electrode tabs, and the lead 400 may be connected to the metal plate.

Referring to FIG. 9, the coupling member 620 may include a first coupling member 621 and a second coupling member 622. The first coupling member 621 may be coupled with the bottom surface 610a of the accommodating member 610. The second coupling member 620 may be coupled with the lower surface of the cover member 630.

The first coupling member 621 and the second coupling member 620 may be offset from each other. More specifically, the first coupling member 621 and the second coupling member 620 may be offset in the thickness direction of the connection member. Accordingly, the first coupling member 621 and the second coupling member 620 may not interfere with each other.

The first coupling member 621 and the second coupling member 622 may penetrate the electrode tabs. In detail, the first coupling member 621 may penetrate the connection region CA. For example, after the connection region of the electrode tabs is positioned on the first coupling member 621, pressure may be applied to the connection region CA or the first coupling member 621. Accordingly, the first coupling member 621 may penetrate into the connection region. Then, after the cover member 630 is positioned on the uppermost electrode tab, pressure may be applied to the cover member 630. Accordingly, the second coupling member 622 may penetrate into the connection region.

In another embodiment, the connection region CA may include a plurality of holes. The holes may include a first hole corresponding to a position of the first coupling member and a second hole corresponding to a position of the second coupling member. The size of the holes may be greater than or equal to a size of the upper surfaces of the coupling members. After aligning the first hole and the first coupling member, pressure may be applied to the connecting region CA or the first coupling member 621. Accordingly, the first coupling member 621 may penetrate the connecting region. After aligning the second hole and the second coupling member, pressure may be applied to the cover member 630. Accordingly, the second coupling member 622 may penetrate the connecting region.

Thus, the connecting member may include the first coupling member and the second coupling member. In such embodiments, even if a defect occurs in one of the coupling members, the electrode tabs may be electrically connected by the other of the coupling members. And the area of the upper surface and the area of the lower surface of the coupling member may be uniform. Accordingly, the current moving the electrode tabs may be uniform. Further, the pressure transmitted to the coupling member may be reduced. Accordingly, the coupling member may be prevented from being damaged by pressure.

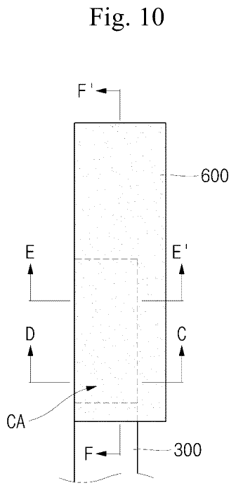

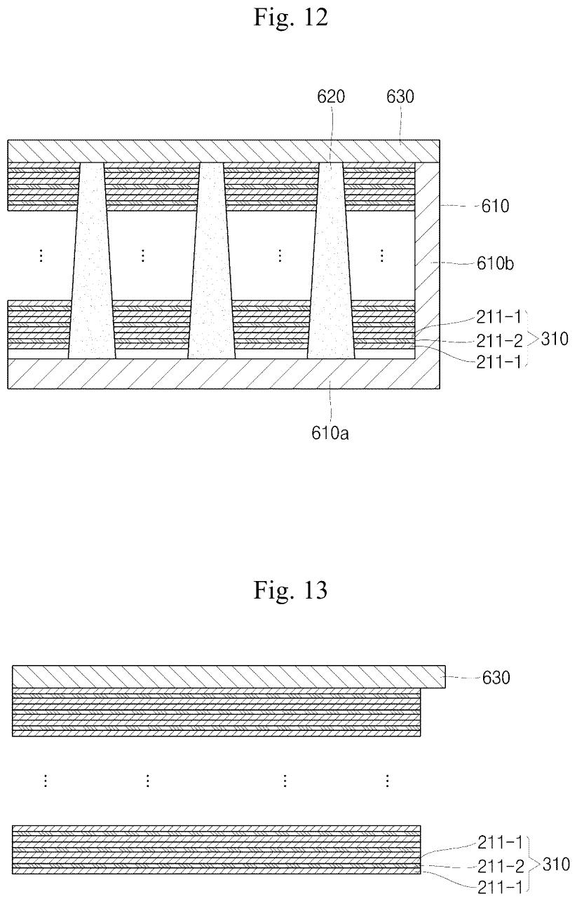

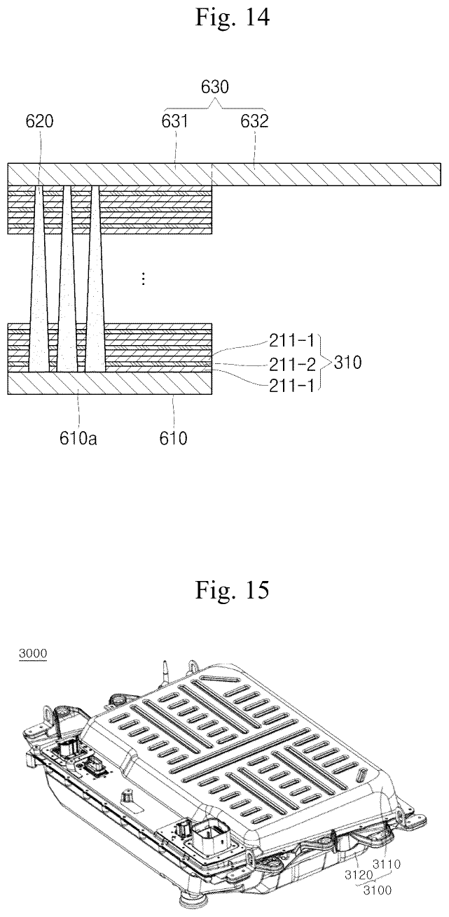

Hereinafter, another embodiment will be described with reference to FIGS. 10 to 14. Commonalities with the embodiments described above will be omitted. In addition, the same drawing reference numerals are given to the same features as those described above.

Referring to FIG. 10, the electrode tab 300 may include the connection region CA. A plurality of electrode tabs formed on each current collector may be electrically connected at the connection region CA. The connection region CA may be disposed in a region between ends of the electrode tab 300.

The connection member 600 may be disposed on the connection region CA. The electrode tabs may be coupled and electrically connected to the connection member 600.

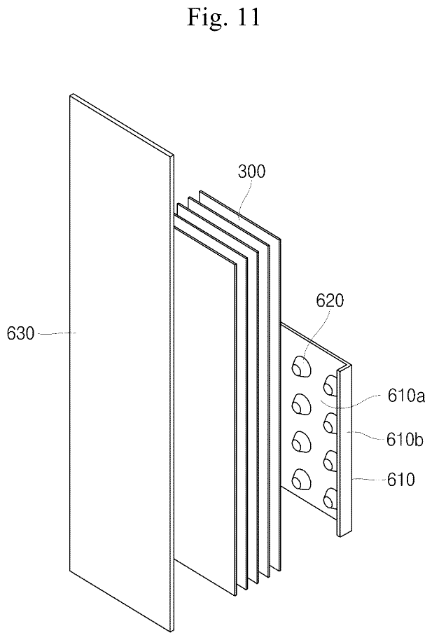

Referring to FIGS. 11 to 14, the connecting member 600 may include the accommodating member 610, the coupling members 620, and the cover member 630. The coupling members 620 penetrate the electrode tabs. Since the coupling members 620 are the same as in the previously described embodiment, further description thereof will be omitted. The accommodating member 610 may accommodate or support the electrode tabs. Since the accommodating member 610 is the same as in the previously described embodiment, further description thereof will be omitted.

Unlike the previously described embodiments, the accommodating member 610 and the cover member 630 may have different sizes. In particular, the length of the cover member 630 may be longer than the length of the accommodating member 630. Thus, the ends of the accommodating member 610 and the ends of the cover member 630 are offset from each other. Accordingly, the ends of the electrode tabs are disposed between the ends of the accommodating member 610 and the ends of the cover member 630. That is, the accommodating member 610 is disposed in a region between the ends of the electrode tabs. And the cover member 630 is disposed in a region between the ends of the electrode tabs and is disposed over an outer area of the electrode tabs.

The cover member 630 may be formed from a metal. For example, the cover member 630 may include the same metal as the first metal layer 211-1 or the second metal layer 221-1. In a specific example, the cover member of the first electrode tab may include aluminum and the cover member of the second electrode tab may include copper or nickel.

The accommodating member 610 may include a metallic material or a non-metallic material. The cover member 630 may be in contact with the electrode tabs. In detail, the cover member 630 may be in direct contact with the uppermost electrode tab. Therefore, the cover member 630 and the electrode tabs may be electrically connected. The accommodating member 610 may be in contact with or separated from the electrode tabs. In detail, the accommodating member 610 may be in contact with or separated from the lowermost electrode tab.

Since the cover member 630 is long, the cover member 630 may serve as the lead. That is, the cover member 630 may extend to the outside of the case 100 to be connected to an external terminal. Thus, the process of welding the electrode tab and the lead may be omitted.

The electrode assembly according to embodiments of the present disclosure includes first and the second electrodes in the form of composite substrates. Accordingly, the weight of the electrode assembly is reduced.

The first electrode and the second electrode according to embodiments of the present disclosure each include electrode tabs. The electrode tabs are electrically connected by a connecting member. The connecting member includes an accommodating member that accommodates the electrode tabs, the coupling member that electrically connects the electrode tabs, and a cover member that covers the electrode tabs. The coupling member penetrates the electrode tabs. Accordingly, the electrode tabs including the composite substrate are electrically connected by the coupling member.

Therefore, the electrode assembly according to the embodiment may electrically connect the electrode tabs without the process of forming the separate substrate tab.

The cover member may be formed longer than the accommodating member. The cover member may also be disposed in the outer region of the electrode tabs. The cover member may extend to the outside of the case. Therefore, the cover member may be the lead. Thus, the electrode assembly according to another embodiment does not require the electrode tab and the lead to be welded together. Accordingly, various problems occurring during welding may be solved.

The secondary battery according to embodiments of the present disclosure may be used in portable small electronic devices such as smartphones, feature phones, notebook computers, digital cameras, and camcorders. A battery module and a battery pack including a plurality of secondary batteries may be used as a power source for driving a motor of a hybrid vehicle or an electric vehicle and as a battery for storing power. The plurality of secondary batteries in a battery module may be connected to each other in series, parallel, or series/parallel by a bus bar.

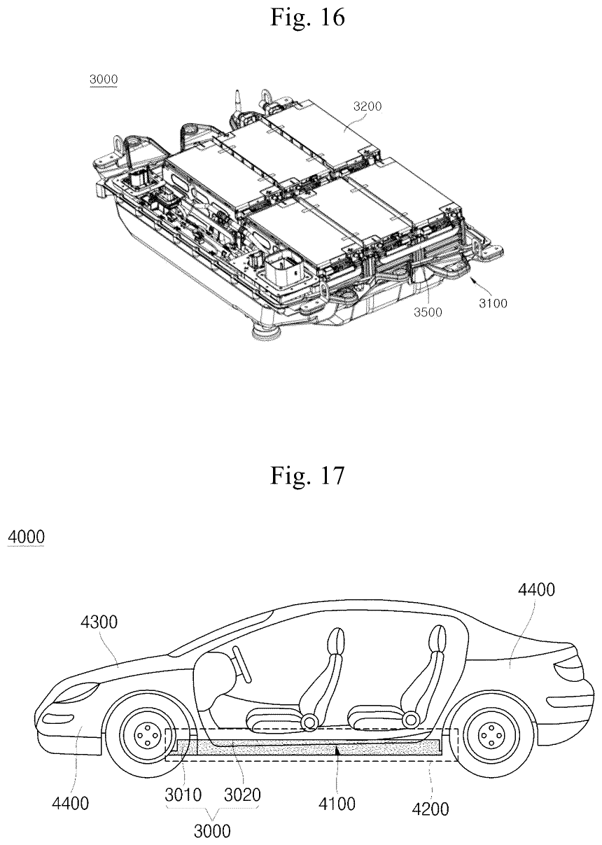

FIGS. 15 and 16 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 17, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle.

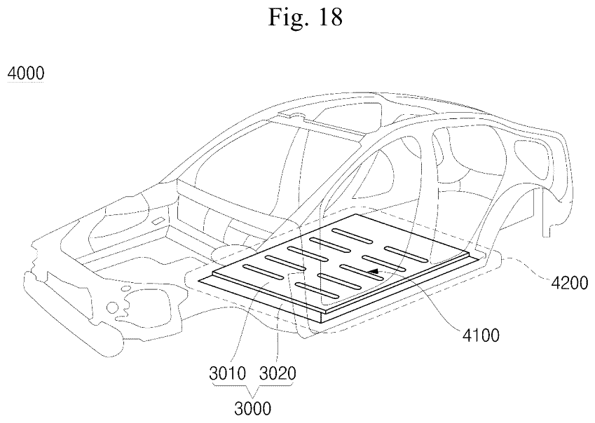

In FIG. 18, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. An electrode assembly comprising:
a first electrode;
a second electrode; and
a separator between the first electrode and the second electrode,
wherein the first electrode comprises a first current collector comprising a first uncoated portion, a first active material layer on the first current collector, and a plurality of first electrode tabs formed by the first uncoated portion and comprising a connection region,
wherein the second electrode comprises a second current collector comprising a second uncoated portion, a second active material layer on the second current collector, and a plurality of second electrode tabs formed by the second uncoated portion and comprising a connection region,
wherein at least one of the first current collector and the second current collector comprises a resin layer and a metal layer on surfaces of the resin layer,
wherein a connection member is disposed on the connection region of at least one of the first electrode tabs and the second electrode tabs, and
wherein the connection member comprises an accommodating member that accommodates the first electrode tabs or the second electrode tabs, a plurality of coupling members penetrating the first electrode tabs or the second electrode tabs, and a cover member that covers the first electrode tabs or the second electrode tabs.

2. The electrode assembly as claimed in claim 1, wherein the accommodating member comprises a bottom surface disposed under a lowermost electrode tab of the first electrode tabs or the second electrode tabs, and
wherein the coupling members are disposed on the bottom surface.

3. The electrode assembly as claimed in claim 2, wherein each of the coupling members comprises a lower surface on the bottom surface and an upper surface, and
wherein a width of each of the coupling members decreases from the lower surface to the upper surface.

4. The electrode assembly as claimed in claim 2, wherein an area of the coupling members is 50% to 80% of a total area of the bottom surface.

5. The electrode assembly as claimed in claim 2, wherein a length of each of the coupling members is 1 to 1.1 times a sum of the thicknesses of the first electrode tabs or the second electrode tabs.

6. The electrode assembly as claimed in claim 2, wherein the accommodating member further comprises a first side and a second side connected to the bottom surface,
wherein the first side covers a side of the first electrode tabs or the second electrode tabs in the longitudinal direction of the first electrode tabs and the second electrode tabs, and
wherein the second side covers a side of the first electrode tabs or the second electrode tabs in the width direction of the first electrode tabs or the second electrode tabs.

7. The electrode assembly as claimed in claim 6, wherein the connecting region is formed at an end of the first electrode tabs or the second electrode tabs.

8. The electrode assembly as claimed in claim 6, wherein the connection region is formed in a region between the ends of the first electrode tabs or the second electrode tabs.

9. The electrode assembly as claimed in claim 2, wherein the coupling members comprise a conductive material.

10. The electrode assembly as claimed in claim 2, wherein the accommodating member and the cover member comprise a metal or a non-metal.

11. The electrode assembly as claimed in claim 1, wherein the coupling members are first coupling members and the connection member further comprises second coupling members disposed on the lower surface of the cover member, and
wherein the second coupling members offset from the first coupling members.

12. The electrode assembly as claimed in claim 1, wherein lengths of the accommodating member and the cover member are different.

13. The electrode assembly as claimed in claim 12, wherein the length of the cover member is longer than the length of the accommodating member.

14. The electrode assembly as claimed in claim 13, wherein the cover member is disposed over an area between the ends of the first electrode tabs or the second electrode tabs and disposed over outer regions of the first electrode tabs or the second electrode tabs.

15. The electrode assembly as claimed in claim 13, wherein the coupling members and the cover member comprise metal, and
wherein the accommodating member comprises metal or non-metal.

16. The electrode assembly as claimed in claim 15, wherein the cover member comprises the same metal as the first collector or the second collector.

17. A secondary battery comprising:
a case; and
an electrode assembly of claim 1 accommodated in the case.

18. The secondary battery as claimed in claim 17, further comprising a first lead connected to the first electrode tabs and a second lead connected to the second electrode tabs.

19. An electrode assembly comprising:
a first electrode;
a second electrode; and
a separator between the first electrode and the second electrode,
wherein the first electrode comprises a first current collector comprising a first uncoated portion, a first active material layer on the first current collector, and a plurality of first electrode tabs formed by the first uncoated portion and comprising a connection region,
wherein the second electrode comprises a second current collector comprising a second uncoated portion, a second active material layer on the second current collector, and a plurality of second electrode tabs formed by the second uncoated portion and comprising a connection region,
wherein at least one of the first current collector and the second current collector comprises a resin layer and a metal layer on surfaces of the resin layer,
wherein a connection member is disposed on the connection region of at least one of the first electrode tabs and the second electrode tabs, and
wherein the connection member comprises an accommodating member that accommodates the first electrode tabs or the second electrode tabs, a coupling member penetrating the first electrode tabs or the second electrode tabs, and a cover member that covers the first electrode tabs or the second electrode tabs.
